(19) United States
(12) Patent Application Publication
(10) Pub. No.: US 2003/0095030 A1
(43) Pub. Date: May 22, 2003

(54) SECURITY SYSTEM

(76) Inventor: JEREMY JOHN GREENWOOD, SUTTON COLDFIELD (GB)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/215,490

(22) Filed: Dec. 18, 1998

(30) Foreign Application Priority Data
Dec. 20, 1997 (GB) 9726828.8
Jul. 27, 1998 (GB) 9816170.6

(51) Int. Cl. H04Q 1/00; G05B 19/00

(52) U.S. Cl. 340/5.61; 340/5.72

(57) ABSTRACT

A security system suitable for a vehicle 10 comprises a remote transponder 16 and a transmitter/receiver 14 which is mounted on the vehicle 10 and which is associated with a controller 12 for controlling the security functions of the vehicle 10 in response to a signal from the transmitter/receiver 14. The transponder 16 includes a transmitting means 18 which is arranged to transmit a security signal in one or more of a predetermined range of channels. The transmitter/receiver 14 is arranged to scan the range of channels and to determine in which one or more of those channels the security signal has been transmitted.

### FIELD OF THE INVENTION

This invention relates to security systems and in particular to a security system suitable for use in a vehicle. The security system is of the type comprising a transmitter which is portable and a receiver which is included in or on the protected unit and which communicate with each other using electromagnetic signals, usually transmitted at radio frequencies.

### BACKGROUND OF THE INVENTION

Such systems can suffer from interference from other sources of radiation which appears around the operating frequency of the system and can prevent its proper operation. It is also known for car thieves to try and cause the remote transmitter to transmit a signal when it is not near the vehicle so that they can try to relay that signal to the vehicle in the hope that the relayed signal will operate the security system.

One proposal to reduce the effects of interference in this type of system is disclosed in U.S. Pat. No. 4,751,396. In this system, a transmitter is arranged to send a signal at a single frequency and is matched to a receiver using both the baud rate of the signal and a code included in the transmission.

Another proposal to reduce the effects of interference in this type of system is disclosed in GB 2311155. In this system the remote transmitter sends its signal at two frequencies and uses frequency key shifting (FSK). Verification that an uncorrupted signal has been received is achieved by comparing a coded portion of the received signal with a codeword stored in the receiver. It is a problem with this system that, if interference is suffered at both the transmitted frequencies, then the chances of either transmission being received are reduced.

The use of FSK necessitates the selection of frequencies which are quite close to each other, for example they are typically spaced apart by about 30 kHz. The narrow spacing is necessary to prevent unwanted harmonics causing interference to other systems.

The use of FSK does not significantly improve security over a system which transmits at only a single frequency because potential thieves merely have to include an FSK demodulator in their code grabbing apparatus. In this manner, the communications between the transmitter and receiver can be captured more or less as easily as if they were to be transmitted on only a single frequency.

### SUMMARY OF THE INVENTION

It is an object of this invention to provide an improved security system.

According to the invention there is provided a security system comprising a remote transponder, a receiver and a security controller, said remote transponder having a predetermined range of operating channels and being arranged to transmit a security signal in at least one channel of said range of channels, said receiver being arranged in use to receive security signals from said remote transponder in any of said range of channels, said security controller being arranged in use to respond to the receipt of a said security signal by said receiver by performing a security function, wherein said receiver further comprises a scanning means arranged in use to scan said range of channels, so as to determine in which channel or channels said security signal has been transmitted.

Said receiver may be arranged to scan said range of channels by tuning itself to each of said channels and remaining tuned thereto for long enough to detect whether or not data is being transmitted in the channel which is being scanned.

Said receiver may be arranged to abandon the scanning of a channel if it does not detect the transmission of data in that channel.

Said receiver may further comprise an automatic frequency control (AFC) means arranged in use to substantially centre said receiver onto data being transmitted in a channel which is being scanned.

Said receiver may be arranged to remain tuned to a channel in which data has been detected until it determines whether or not the detected data comprises a said security signal which is plausible.

Said receiver, if it determines the detected data comprises a said security signal which is plausible, may be arranged to remain tuned to that detected data until said security signal has been received.

Said receiver may be arranged to abandon the scanning of a particular channel in which a said security signal which is plausible was detected if that security signal becomes implausible.

Said receiver may be arranged to continue its scanning of the channels after receiving said security signal in any one of said channels or after abandoning the scanning of any one of said channels.

Said receiver may be arranged to remain tuned to a further one of said channels if data is detected in that further channel and to remain tuned thereto for long enough to determine if the data detected in that further channel comprises a said security signal which is plausible, whereby, if said security signal is transmitted in a plurality of said channels, said receiver can determine in which one or more of said channels said security signal is or was capable of detection and can provide to said security controller any such security signal which is received and an indication of the channel or channels in which said security signal was received.

Said receiver may be arranged to remain tuned to a said channel in which data is detected until the expiry of a predetermined time period, the expiry of which time period without the determination of the presence of plausible data being indicative that said detected data does not comprise or no longer comprises a said security signal which is plausible.

Said receiver may further comprise a counter associated with a said channel and said receiver may be arranged to increment said counter for its associated channel if said receiver determines that the detected data in that channel does not comprise a said security signal which is plausible.

Said receiver may further comprise a counter associated with a said channel and said receiver may be arranged to increment said counter for its associated channel if the detected data in that channel over-runs or if it under-runs a said security signal which is plausible.

Said counter may be incremented by a different value for an over-run than for an under-run.

Said receiver may be arranged to reduce the sensitivity of its reception for a said channel if the counter associated with said channel exceeds a predetermined value. Said sensitivity may be reduced in predetermined stages and said predetermined stages may comprise one or more of 4, 8, and 12 dB.

Said receiver may be arranged to stop receiving in a said channel if, despite said reduction or reductions in sensitivity, the detected data in that channel continues to be determined as implausible.

The counter for a said channel may be decremented at, towards or after a scan through said range of channels. The counter for a said channel may be decremented by a lower value at, towards or after the end of a scan than said counter would be incremented for an over-run or for an under-run during a scan, whereby said counter may be arranged to adopt a fast-on but slow-off measure of data plausibility for said channel.

Said receiver may be arranged to provide to said security controller a signal indicative of a said channel in which a said security signal which is plausible was received.

Said security controller may be arranged to compare the channel in which a said security signal which is plausible is first received with a further said channel in which a following transmission thereof is received and to determine, from the spacing between said channels in which said security signal is received, whether said security signal has been relayed using a relaying means, or has suffered interference or has been corrupted.

Said remote transponder may be arranged to transmit said security signal first in one of said channels and then in a further one or more than one of said channels. Said channel or channels in which a said security signal is transmitted may be preset in said remote transponder.

Said transponder may further comprise a surface acoustic wave resonator (SAW) resonator associated with each said channel which is preset in said transponder and the frequency of each said preset channel or channels may be preset by the resonant frequency of said associated resonator.

When a said security signal is transmitted in a plurality of said channels, said respective associated surface acoustic wave resonators may be connected in parallel and, each time said security signal is transmitted, a first one of said resonators may be turned on to cause said security signal to be transmitted in a said channel associated with that resonator and that first resonator may then be turned off and the next one of said resonators may then be turned on to cause the same security signal to be transmitted in a said channel associated with that next one of the resonators.

When a said security signal is transmitted in a plurality of said channels, the resonant frequencies of said surface acoustic wave resonators may be selected such that there is a predetermined frequency gap between the channels in which said security signal is transmitted.

Said remote transponder may be arranged to indicate to said receiver in which one or more than one of said range of channels a said security signal is to be transmitted.

Said remote transponder may be arranged to send an indicating signal to said receiver, which indicating signal indicates the channel or channels in which a said security signal is to be transmitted.

Said security controller may be arranged to send a specifying signal to said remote transponder in which specifying signal said security controller may be arranged to specify to said remote transponder the channel or channels in which said remote transponder is to transmit a said security signal.

When a said security signal is transmitted in a plurality of said channels, the frequency of at least one of said at least two channels in which said remote transponder transmits its signals may be alterable between transmissions of a said security signal.

The frequencies of said channels comprising said predetermined range of channels may be pre-programmed into said remote transponder and into at least one of said receiver or said security controller.

Said remote transponder may be arranged to transmit a said security signal in more than two of said predetermined range of channels and said security controller may be arranged to respond to said security signal only if it is received by said receiver in at least two channels. Said predetermined range of channels may be 32 in number or may be 10 in number.

Said channels used for transmission of a said security signal may be of substantially equal width. When a said security signal is transmitted in two or more channels, the channels used for transmission of said security signal may be spaced apart by at least one channel.

Said predetermined range of channels may have a bandwidth in the order of 480 kHz.

Said security signal may be transmitted in two or more channels and said channels used for transmission of the security signal may be spaced apart by at least three channels. Said predetermined range of channels may have a bandwidth in the order of 1 MHz.

The security system may further comprise a transmitting means which is associated with said security controller and said remote transponder may be arranged to transmit a said security signal only in response to a request signal transmitted to it by said transmitting means.

When said security controller and said receiver are fitted to a vehicle, said request signal may be transmitted as a result of an action of a user of said vehicle triggering the transmitting means. Said vehicle may have a closure member which includes an opening mechanism and said transmitting means may be triggered by operation of said opening mechanism.

Said receiver may be arranged, after completing a scan through said range of channels, to wait for a predetermined delay period before commencing another scan.

The invention also provides a method of controlling a security system, the system comprising a remote transponder, a receiver and a security controller, said remote transponder having a predetermined range of operating channels and being arranged to transmit a security signal in at least one channel of said range of channels, said receiver being arranged in use to receive security signals from said remote transponder in any of said range of channels, said security controller being arranged in use to respond to the receipt of a said security signal by said receiver by performing a security function, wherein said receiver further comprises a scanning means and the method includes scanning said range of channels, so as to determine in which channel or channels said security signal has been transmitted.

The method may include scanning said range of channels by tuning said receiver to each of said channels and remaining tuned thereto for long enough to detect whether or not data is being transmitted in the channel which is being scanned.

The method may include abandoning the scanning of a channel if said receiver does not detect the transmission of data in that channel.

Said receiver may further comprise an automatic frequency control (AFC) means and the method may include using said automatic frequency control means to substantially centre said receiver onto data being transmitted in a channel which is being scanned.

The method may include remaining tuned to a channel in which data has been detected until determining whether or not the detected data comprises a said security signal which is plausible.

The method may include remaining tuned, if said receiver determines that the detected data comprises a said security signal which is plausible, to the detected data until said security signal has been received.

The method may include abandoning the scanning of a particular channel in which a said security signal which is plausible was detected if that signal becomes implausible.

The method may include continuing to scan said range of channels after receiving a said security signal in any one of said channels or after abandoning the scanning of any one of said channels.

The method may include keeping said receiver tuned to a further one of said channels if data is detected in that further channel and keeping said receiver tuned thereto for long enough to determine if the data detected in that further channel comprises a security signal which is plausible, whereby, if a said security signal is transmitted in a plurality of channels, the method includes determining in which one or more of said channels said security signal is or was capable of detection and providing to said security controller any such security signal which is received and an indication of the channel or channels in which said security signal was received.

The method may include keeping said receiver tuned to a said channel in which data is detected until the expiry of a predetermined time period, the expiry of which time period without determining the presence of plausible data indicating that the detected data does not comprise or no longer comprises a plausible security signal.

Said receiver may further comprise a counter associated with a said channel and the method may include incrementing said counter for said channel if said receiver determines that the detected data in that channel does not comprise a security signal which is plausible.

Said receiver may further comprise a counter associated with a said channel and the method may include incrementing said counter for a said channel if the detected data in that channel over-runs or if it under-runs a security signal which is plausible.

The method may include incrementing said counter by a different value for an over-run than for an under-run.

The method may include reducing the sensitivity of reception of said receiver for a said channel if said counter exceeds a predetermined level. The method may include including reducing the sensitivity in predetermined stages.

The method may include stopping said receiver from receiving in a said channel if, despite reducing the sensitivity of said receiver, the detected data in that channel continues to be determined as implausible.

The method may include decrementing said counter for a said channel at, towards or after a scan through said range of channels. The method may include decrementing said counter for a said channel by a lower value at, towards or after the end of a scan than said counter would be incremented for an over-run or for an under-run during a scan, whereby the method includes said counter adopting a fast-on but slow-off measure of data plausibility for a channel.

The method may include providing said security controller with a signal indicative of a said channel in which a security signal which is plausible was received.

The method may include comparing a said channel in which a security signal which is plausible is first received with a said channel in which a following transmission thereof is received and determining, from the spacing between said channels in which said security signal is received, whether said security signal has been relayed using a relaying means or has suffered interference or has been corrupted.

The method may include transmitting a said security signal first in one of said channels and then in a further one or more than one of said channels. The method may include indicating from said remote transponder to said receiver in which one or more than one of said range of channels said security signal is to be transmitted.

The method may include sending to said receiver from said remote transponder an indicating signal which indicates a said channel or channels in which said security signal is to be transmitted.

The method may include sending a specifying signal to said remote transponder from said security controller, in which specifying signal said security controller specifies a said channel or channels in which said remote transponder is to transmit a said security signal.

The method may include, when said security signal is transmitted in a plurality of channels, altering between transmissions of said security signal the frequency of at least one of the plurality of channels in which said remote transponder transmits a said security signal.

The method may include transmitting a said security signal in more than two of said predetermined range of channels and arranging said security controller to respond to said security signal only if it is received by said receiver in at least two channels.

The method may include, when a said security signal is transmitted in two or more channels, spacing apart those channels by at least one channel.

The method may include waiting for a predetermined delay period after completing a scan through said range of channels before commencing another scan.

### BRIEF DESCRIPTION OF THE DRAWINGS

Preferred embodiments of the invention will now be described by way of example only and with reference to the accompanying drawings, in which:

FIG. 1 is a schematic view of a vehicle including a security system according to the invention;

FIG. 2 is a flow chart of a method of operation of a remote transponder of the security system of FIG. 1;

FIG. 3 is a flow chart of a method of operation of a receiver of a security controller of FIG. 1; and

FIGS. 4a to 4c are a graphical representation of part of the method of FIG. 3.

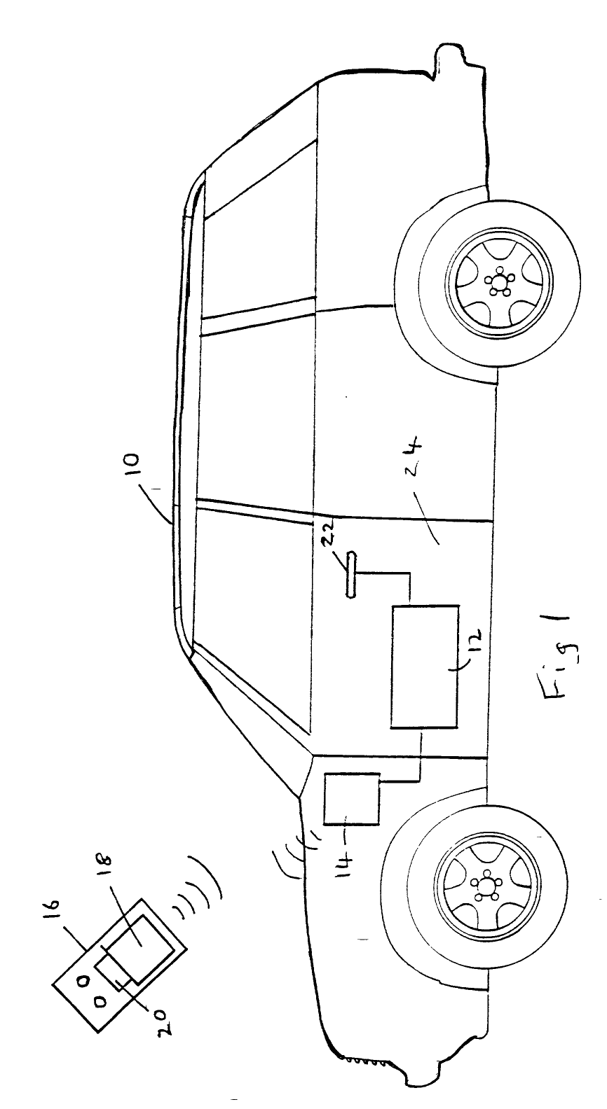

### DESCRIPTION OF PREFERRED EMBODIMENTS OF THE INVENTION

Referring to the figures, a vehicle 10 comprises a security system which includes a security controller 12 which has associated with it a first transmitter/receiver unit 14 and which controls the operation of various items on the vehicle including the door locks and an engine imobiliser.

The security system also includes a remote transponder 16 which is portable and intended in use to be carried by a user. The transponder 16 includes a second transmitter/receiver unit 18 and an associated control circuit 20 and is arranged to communicate selectively with the security controller 12.

The vehicle 10 has a closure member operating mechanism in the form of a door handle 22 on the driver's door 24 which has a microswitch (not shown separately) in it to enable the controller 12 to detect when the door handle 22 is operated to gain entry to the vehicle 10. The controller 12 reacts to operation of the door handle 22 by causing the first transmitter/receiver unit 14 to transmit a request signal to the remote transponder 16 as will be described below.

The transmitter/receiver units 14, 18 each have an operative bandwidth in the order of 480 kHz. This total operative band is divided into 32 frequency bands or channels, each about 15 kHz in width. The channels are adjacent to one another, are non-overlapping and are distinguishable from each other by their frequency of operation Fn. The channels rise in frequency from (n=1) to (n=nₘₐₓ). In this embodiment, having 32 channels, n rises between successive channels from (n=1) to (n=32) evenly spaced across the total bandwidth of 480 kHz.

Each of the transmitter/receiver units 14, 18 is arranged such that it can transmit in each of the channels independently, receive signals in each of the channels, and distinguish between signals received in different channels. The control circuit 20 in the transponder 16 and the security controller 12 on the vehicle 10 control the timing and frequency of the transmissions and process the signals received by their respective receivers.

When a user approaches the vehicle 10 and lifts the door handle 22, the controller 12 causes the first transmitter/receiver unit 14 to transmit in one of the channels a request signal, for example at 125 kHz, which requests that the transponder 16 send a coded security signal in response.

The transponder 16 is arranged to respond to the request signal by transmitting in two of the channels and the response comprises a coded security signal which is transmitted first in one channel and then in a second one. Using successive transmissions means that harmonics are not generated and the problems associated with frequency shift keying (FSK) do not occur, which in turn means that channel spacing is not restricted as it might be if FSK were to be used.

The channels used for the response are fixed in the transponder 16 during manufacture by the inclusion of surface acoustic wave resonators (SAWs) (not shown separately) in the control circuit 20. The SAWs are connected in parallel and arranged to be capable of being switched on independently and selectively.

To send the response, one of the SAWs is turned on using a pin diode and this results in the security signal being transmitted in the channel in which that particular SAW's resonant frequency falls. This SAW is then turned off and the other SAW is turned on, again using a pin diode. The security signal is then transmitted in the channel in which the resonant frequency of the second SAW falls. The second SAW is then turned off and transmission of the response for that receipt of the request signal is complete.

The SAWs are selected such that their nominal resonant frequencies result in the transmission channels of the response have a spacing of at least three or four channels between them, or more preferably a spacing of at least 100 kHz.

The SAWs' frequencies cannot be guaranteed as fixed, as their nominal resonant frequency will drift with time and variations in temperature. Because of this, it is not possible to specify with absolute certainty which of the channels will be used to transmit the response and the receiver/transmitter unit 14 must therefore scan all the channels to find the one or more than one in which the security signal can be detected.

To scan across all the channels Fn to Fnₘₐₓ, the transmitter/receiver unit 14 scans the channels by tuning itself to each one in turn and waiting in each channel Fn long enough to detect whether there is data present in an expected format, which can then be analysed to determine if it comprises a security signal. One example of data in an expected format can be achieved by providing the security signal with a long preamble of logic “1” bits so as to make it easy to find and then keeping the receiver of the transmitter/receiver unit 14 tuned into each channel long enough to detect a recognisable portion of this preamble.

When the transmitter/receiver unit 14 has found a channel in which data appears to be present, it uses an automatic frequency control process to centre itself onto that detected data and stays tuned to it until the security signal is complete and plausible, until the data becomes implausible (e.g. by over-running or under-running), or until a time-out has expired.

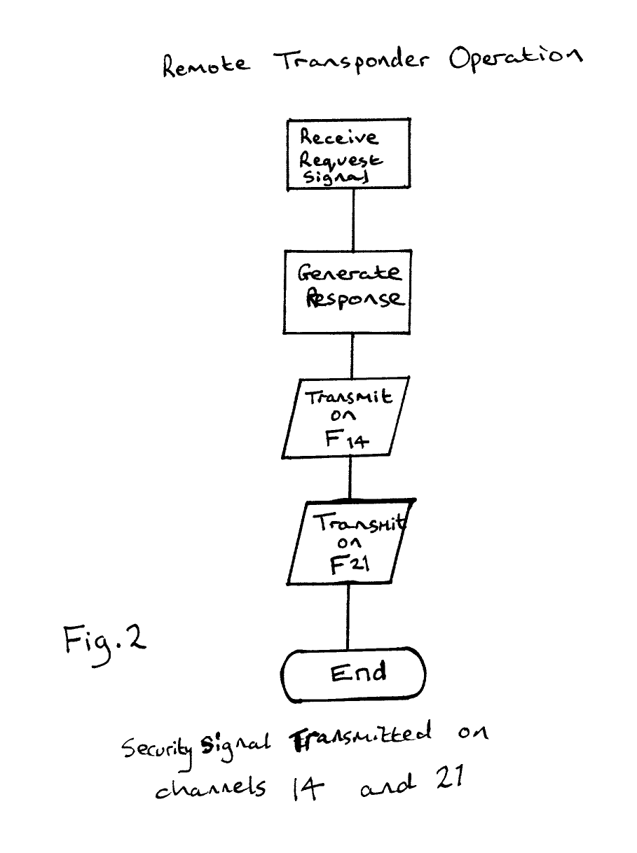

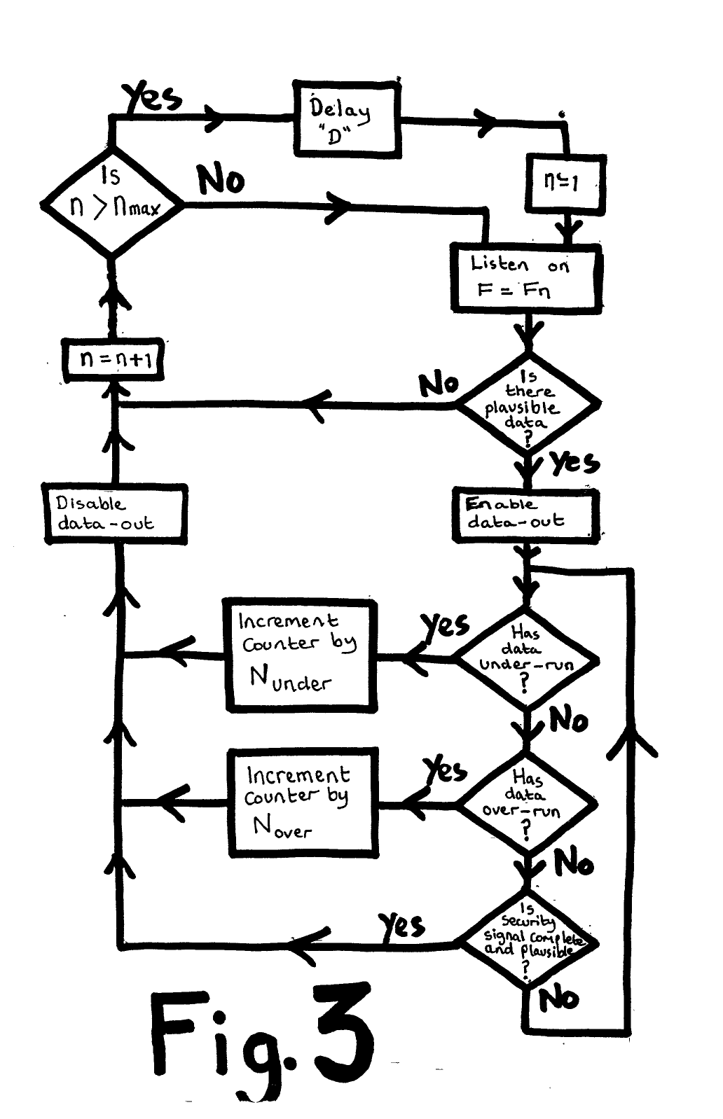

The scanning operation is best understood in greater detail with particular reference to FIG. 3 and FIGS. 4a to 4c.

In FIG. 4a, the basic scanning operation can be observed but without the detection of data in any of the channels. In the basic scanning operation, the transmitter/receiver unit 14 is constantly scanning through all 32 channels in succession looking for the security signal. Each scan starts at the channel having the lowest frequency Fn (where n=1). If no data is detected, the scan moves onto the next channel F(n=n+1). If the transmitter/receiver unit 14 scans through all 32 of the channels (Fn to Fnₘₐₓ) without detecting data, the scan starts again at F(n=1). In any case, once Fnₘₐₓ has been scanned, n is set back to 1, so that the next scan is ready to start.

With particular reference to FIGS. 3 and 4b, a delay period D is optionally included between scans so as to reduce power consumption. The delay period D is preferably set at a length which is not long enough to cause inconvenience to a user who might have to wait for the delay D to end before the scanning could start. A suitable and convenient delay D might be found to exist in the range of 32 to 256 ms.

In FIG. 4c, only one scan from either of FIGS. 4a or 4b is shown, the transmitter/receiver unit 14 having transmitted the security signal in two channels, first in F(n=14) and then in F(n=21) in accordance with the flow chart of FIG. 2. Data can be seen to have been detected in channels 14 and 21 and when such detected data is determined within the receiver of the transmitter/receiver 14 to be a plausible security signal, it is passed to the remainder of the security controller 12 for implementation as a predetermined security function.

When data has been detected in the expected format in any particular channel, found to be plausible and passed to the remainder of the security controller, the data output to the security controller from the transmitter/receiver 14 is disabled and the next channel in succession is scanned, in search of a repeat transmission (such as the one found in the above example in channel 21).

If data detected in a channel under-runs or over-runs a plausible security signal, that event is noted by incrementing by a constant N_{und} or Nₒᵥₑᵣ respectively a counter value for a register associated with that channel. A different constant is used when incrementing the counter for each of an under-run and an over-run. The constants are not equal and the constant used for an over-run is the greater because an over-run usually indicates that the signal has been subjected to interference.

If the counter value for a given channel reaches one of a series of thresholds, the transmitter/receiver unit 14 is arranged to assume that there is an interfering signal which is causing it to waste time looking for the security signal in that channel at that time. When this happens, the transmitter/receiver unit 14 first reduces the sensitivity of the receiver of its transmitter/receiver unit 14 for the affected channel and does so in graduated steps (for example 4, 8, 12 dB).

If the counter value exceeds a preset maximum despite the reduction or reductions in sensitivity, the transmitter/receiver unit 14 will finally shut down for that channel or channels which is/are then by-passed completely until the counter has been cleared as outlined below.

At, towards or after the end of each scan, the counter value for the counter of each channel is decremented. The counter is decremented by a smaller amount than the value of either N_{und} or N_{over.} For example, N_{und} may be 4, Nₒᵥₑᵣ may be 5 and the counter decremented at, towards or after each scan by 1. In this manner, the counter adopts a “fast-on” but “slow-off” measure of data plausibility for each channel. This feature means that it takes 4 or 5 scans, without either under-running or over-running, to clear the counter for a channel for each under-run or over-run as the case may be of data in that channel.

If a channel is being by-passed because its counter has exceeded a predetermined threshold, which might for this example be between 12 and 16, the counter is still decremented by 1 at, towards or after each scan along with the counters for all the other channels. In this manner, any affected channel is only ignored for a predetermined number of scans, e.g. 12 to 16, and the system can thus accommodate transient interference in any one or more than one of the channels.

A different way of deciding that the data is implausible would be to stay centred onto a string of detected data for a predetermined time period, the expiry of which could be pre-programmed into the receiver of the transmitter/receiver unit 14 as indicative that the data being received does not comprise a plausible security signal. For example, such a time-out could be set to correspond to an over-run condition.

When the transmitter/receiver unit 14 has detected a plausible security signal and passed it on to the remainder of the security controller 12, it is followed by a message which identifies the channel in which the security signal was detected. The security controller 12 uses this information about that channel to make a comparison with the other channel (if any) in which the security signal was detected and to judge whether the channel spacing is sufficient to indicate a valid response or one which has suffered interference. If the security signal is detected in only one channel, then information about which channel that might be is of limited use, except for example to verify that the security signal was detected in a valid channel.

By sending out the security signal on first one channel and then on another one, instead of for example both at the same time, the likelihood of generating undesirable harmonics is significantly reduced.

In a second embodiment of the invention, the response comprises the security signal sent in only one channel and thus saves the cost of the second SAW. Such an embodiment is useful in a market where there is a reduced risk of vehicle theft. In most cases, however, it is preferred to transmit the security signal in two or more channels as described in the first embodiment so as to provide protection against interference in any one channel.

The use of a bandwidth of about 480 kHz, still around a central frequency of about 433 MHz and which is divided into 32 channels each being about 15 kHz wide, could be applied to other embodiments of the invention. Embodiments in which the security signal is transmitted on more than one channel have the advantage that a channel spacing of three or four can be used to transmit the security signals closer to each other than would be easy to detect using a commercially available UHF receiver of reasonable cost and which might have a bandwidth of, for example, 500 kHz.

In this manner, a thief trying to use a code scanner based on such technology would find it more difficult to collect the security signal and to retransmit it. The security signals would appear as a single signal and that is what would be retransmitted after capture or relaying. Because the retransmitted or relayed signal is not two signals of narrow bandwidth which are close to each other, the security controller 12 could determine that such a signal was false or corrupted. Channel spacing of three or four also provides sufficient spacing to take account of the tolerances and drift of any SAW used.

In a third embodiment of the invention, the channels used for transmitting the security signal can be altered by the remote transponder 16 between transmissions of the response and the security controller 12 sends a specifying signal to the remote transponder 16 in order to specify in which one or more of the channels the transponder 16 is to send the security signal.

In this embodiment, the controller 12 is preferably arranged to select a different pair of channels for each response, i.e. each time the door handle 22 is lifted. This is achieved by an algorithm in the controller 12 (e.g. a random number generator which operates in the range of 1 to 32) and makes it harder for a thief to anticipate which channels will be used next.

In a fourth embodiment of the invention, the frequency of the response can also be altered under the control of the remote transponder 16. Upon receipt of a request signal, the remote transponder 16 sends an indicating signal to the transmitter/receiver 14 in order to specify in which one or more of the channels the security signal is to be sent.

Interference or corruption, for example from amateur radio transmissions, is usually limited to a relatively narrow bandwidth of about 50 kHz. Therefore, provided the channels chosen or specified for the third and fourth embodiments are not adjacent, the security signal will still be received and plausible in at least one channel even if the frequency of the interference falls within one of the channels.

The spacing of the channels in this case is such that they are always spaced apart by at least one channel so that a 50 kHz signal cannot interfere with both channels. If a different bandwidth or a different number of channels are used, the channel spacing would merely be altered to suit the new bandwidth or number of channels so as to avoid interference from this or another interfering signal.

In a fifth embodiment of the invention, the transponder 16 is arranged to transmit a signal in each of three or more of the channels. The receiver is arranged to scan all of the channels and to respond by producing a remobilisation signal if it receives the signal in at least any two of the channels. In this way the exact frequency of the transmission is not critical, the only requirement being that two signals in different channels are received. This makes the fluctuations in frequency which can result from temperature changes less harmful to the system, whilst allowing the system to operate if there is interference in one of the channels.

The transmitter/receiver unit 14 does not need to be a separate unit and could be included in the security controller 12 in this and in any other embodiment.

In each embodiment, if a thief tries to trigger the transponder 16 when it is remote from the vehicle and tries to relay the transmitted signal to the vehicle 10, he will encounter at least two problems. Firstly, he is unlikely to be able to transmit a signal to the transponder 16 which is in the correct channel to produce a response. Secondly, if he does produce a response, he is unlikely to be able to detect accurately enough in which channel or channels the security signal is being transmitted to be able to relay it correctly.

The frequency band should not be considered as limited to 480 kHz in any embodiment. For example, it may be possible to use a bandwidth of 1 MHz and to divide it into 10 channels. This would provide a channel bandwidth of 100 kHz and a channel spacing of only one channel would be adequate to substantially reduce the likelihood of interference. In addition, the cost of equipment which can distinguish between frequency bands of the order of 100 kHz is currently high and is not likely to be in the possession of most car thieves.

What is claimed is:

1. A security system comprising a remote transponder, a receiver and a security controller, said remote transponder having a predetermined range of operating channels and being arranged to transmit a security signal in at least one channel of said range of channels, said receiver being arranged in use to receive security signals from said remote transponder in any of said range of channels, said security controller being arranged in use to respond to the receipt of a said security signal by said receiver by performing a security function, wherein said receiver further comprises a scanning means arranged in use to scan said range of channels, so as to determine in which channel or channels said security signal has been transmitted.

2. A security system according to claim 1, wherein said receiver is arranged to scan said range of channels by tuning itself to each of said channels and remaining tuned thereto for long enough to detect whether or not data is being transmitted in the channel which is being scanned.

3. A security system according to claim 2, wherein said receiver is arranged to abandon the scanning of a channel if it does not detect the transmission of data in that channel.

4. A security system according to claim 2, wherein said receiver further comprises an automatic frequency control (AFC) means arranged in use to substantially centre said receiver onto data being transmitted in a channel which is being scanned.

5. A security system according to claim 2, wherein said receiver is arranged to remain tuned to a channel in which data has been detected until it determines whether or not the detected data comprises a said security signal which is plausible.

6. A security system according to claim 5, wherein said receiver, if it determines the detected data comprises a said security signal which is plausible, is arranged to remain tuned to that detected data until said security signal has been received.

7. A security system according to claim 6, wherein said receiver is arranged to abandon the scanning of a particular channel in which a said security signal which is plausible was detected if that security signal becomes implausible.

8. A security system according claim 1, wherein said receiver is arranged to continue its scanning of the channels after receiving said security signal in any one of said channels or after abandoning the scanning of any one of said channels.

9. A security system according to claim 2, wherein said receiver is arranged to remain tuned to a further one of said channels if data is detected in that further channel and to remain tuned thereto for long enough to determine if the data detected in that further channel comprises a said security signal which is plausible, whereby, if said security signal is transmitted in a plurality of said channels, said receiver can determine in which one or more of said channels said security signal is or was capable of detection and can provide to said security controller any such security signal which is received and an indication of the channel or channels in which said security signal was received.

10. A security system according to claim 5, wherein said receiver is arranged to remain tuned to a said channel in which data is detected until the expiry of a predetermined time period, the expiry of which time period without the determination of the presence of plausible data being indicative that said detected data does not comprise or no longer comprises a said security signal which is plausible.

11. A security system according to claim 5, wherein said receiver further comprises a counter associated with a said channel and said receiver is arranged to increment said counter for its associated channel if said receiver determines that the detected data in that channel does not comprise a said security signal which is plausible.

12. A security system according to claim 5, wherein said receiver further comprises a counter associated with a said channel and said receiver is arranged to increment said counter for its associated channel if the detected data in that channel over-runs or if it under-runs a said security signal which is plausible.

13. A security system according to claim 12, wherein said counter is incremented by a different value for an over-run than for an under-run.

14. A security system according to claim 11, wherein said receiver is arranged to reduce the sensitivity of its reception for a said channel if the counter associated with said channel exceeds a predetermined value.

15. A security system according to claim 14, wherein said sensitivity is reduced in predetermined stages.

16. A security system according to claim 15, wherein said predetermined stages comprise one or more of 4, 8, and 12 dB.

17. A security system according to claim 11, wherein said receiver is arranged to stop receiving in a said channel if, despite said reduction or reductions in sensitivity, the detected data in that channel continues to be determined as implausible.

18. A security system according to claim 11, wherein the counter for a said channel is decremented at, towards or after a scan through said range of channels.

19. A security system according to claim 18, wherein the counter for a said channel is decremented by a lower value at, towards or after the end of a scan than said counter would be incremented for an over-run or for an under-run during a scan, whereby said counter is arranged to adopt a fast-on but slow-off measure of data plausibility for said channel.

20 A security system according to claim 5, wherein said receiver is arranged to provide to said security controller a signal indicative of a said channel in which a said security signal which is plausible was received.

21. A security system according to claim 20, wherein said security controller is arranged to compare the channel in which a said security signal which is plausible is first received with a further said channel in which a following transmission thereof is received and to determine, from the spacing between said channels in which said security signal is received, whether said security signal has been relayed using a relaying means, or has suffered interference or has been corrupted.

22. A security system according to claim 1, wherein said remote transponder is arranged to transmit said security signal first in one of said channels and then in a further one or more than one of said channels.

23. A security system according claim 1, wherein said channel or channels in which a said security signal is transmitted is or are preset in said remote transponder.

24. A security system according to claim 23, wherein said transponder further comprises a surface acoustic wave resonator (SAW) resonator associated with each said channel which is preset in said transponder and the frequency of each said preset channel or channels is preset by the resonant frequency of said associated resonator.

25. A security system according to claim 24, wherein, when a said security signal is transmitted in a plurality of said channels, said respective associated surface acoustic wave resonators are connected in parallel and, each time said security signal is transmitted, a first one of said resonators is turned on to cause said security signal to be transmitted in a said channel associated with that resonator and that first resonator is then turned off and the next one of said resonators is then turned on to cause the same security signal to be transmitted in a said channel associated with that next one of the resonators.

26. A security system according to claim 24, wherein, when a said security signal is transmitted in a plurality of said channels, the resonant frequencies of said surface acoustic wave resonators are selected such that there is a predetermined frequency gap between the channels in which said security signal is transmitted.

27. A security system according to claim 1, wherein said remote transponder is arranged to indicate to said receiver in which one or more than one of said range of channels a said security signal is to be transmitted.

28. A security system according to claim 27, wherein said remote transponder is arranged to send an indicating signal to said receiver, which indicating signal indicates the channel or channels in which a said security signal is to be transmitted.

29. A security system according to claim 1, wherein said security controller is arranged to send a specifying signal to said remote transponder in which specifying signal said security controller is arranged to specify to said remote transponder the channel or channels in which said remote transponder is to transmit a said security signal.

30. A security system according to claim 1, wherein, when a said security signal is transmitted in a plurality of said channels, the frequency of at least one of said at least two channels in which said remote transponder transmits its signals is alterable between transmissions of a said security signal.

31. A security system according to claim 1, wherein the frequencies of said channels comprising said predetermined range of channels are pre-programmed into said remote transponder and into at least one of said receiver or said security controller.

32. A security system according to claim 1, wherein said remote transponder is arranged to transmit a said security signal in more than two of said predetermined range of channels and wherein said security controller is arranged to respond to said security signal only if it is received by said receiver in at least two channels.

33. A security system according to claim 1, said predetermined range of channels being 32 in number.

34. A security system according to claim 1, said predetermined range of channels being 10 in number.

35. A security system according to claim 1, wherein said channels used for transmission of a said security signal are of substantially equal width.

36. A security system according to claim 1, wherein, when a said security signal is transmitted in two or more channels, the channels used for transmission of said security signal are spaced apart by at least one channel.

37. A security system according to claim 1, wherein said predetermined range of channels has a bandwidth in the order of 480 kHz.

38. A security system according to claim 37, wherein said security signal is transmitted in two or more channels and said channels used for transmission of the security signal are spaced apart by at least three channels.

39. A security system according to claim 1, wherein said predetermined range of channels has a bandwidth in the order of 1 MHz.

40. A security system according to claim 1, wherein the security system further comprises a transmitting means which is associated with said security controller and said remote transponder is arranged to transmit a said security signal only in response to a request signal transmitted to it by said transmitting means.

41. A security system according to claim 40, wherein, when said security controller and said receiver are fitted to a vehicle, said request signal is transmitted as a result of an action of a user of said vehicle triggering the transmitting means.

42. A security system according to claim 41, said vehicle having a closure member which includes an opening mechanism and said transmitting means being triggered by operation of said opening mechanism.

43. A security system according to claim 1, wherein said receiver is arranged, after completing a scan through said range of channels, to wait for a predetermined delay period before commencing another scan.

44. A method of controlling a security system, the system comprising a remote transponder, a receiver and a security controller, said remote transponder having a predetermined range of operating channels and being arranged to transmit a security signal in at least one channel of said range of channels, said receiver being arranged in use to receive security signals from said remote transponder in any of said range of channels, said security controller being arranged in use to respond to the receipt of a said security signal by said receiver by performing a security function, wherein said receiver further comprises a scanning means and the method includes scanning said range of channels, so as to determine in which channel or channels said security signal has been transmitted.

45. A method according to claim 44, including scanning said range of channels by tuning said receiver to each of said channels and remaining tuned thereto for long enough to detect whether or not data is being transmitted in the channel which is being scanned.

46. A method according to claim 45, including abandoning the scanning of a channel if said receiver does not detect the transmission of data in that channel.

47. A method according to claim 45, said receiver further comprising an automatic frequency control (AFC) means and the method including using said automatic frequency control means to substantially centre said receiver onto data being transmitted in a channel which is being scanned.

48. A method according to claim 45, including remaining tuned to a channel in which data has been detected until determining whether or not the detected data comprises a said security signal which is plausible.

49. A method according to claim 48, including remaining tuned, if said receiver determines that the detected data comprises a said security signal which is plausible, to the detected data until said security signal has been received.

50. A method according to claim 49, including abandoning the scanning of a particular channel in which a said security signal which is plausible was detected if that signal becomes implausible.

51. A method according to claim 50, including continuing to scan said range of channels after receiving a said security signal in any one of said channels or after abandoning the scanning of any one of said channels.

52. A method according to claim 45, including keeping said receiver tuned to a further one of said channels if data is detected in that further channel and keeping said receiver tuned thereto for long enough to determine if the data detected in that further channel comprises a security signal which is plausible, whereby, if a said security signal is transmitted in a plurality of channels, the method includes determining in which one or more of said channels said security signal is or was capable of detection and providing to said security controller any such security signal which is received and an indication of the channel or channels in which said security signal was received.

53. A method according to claim 48 including keeping said receiver tuned to a said channel in which data is detected until the expiry of a predetermined time period, the expiry of which time period without determining the presence of plausible data indicating that the detected data does not comprise or no longer comprises a plausible security signal.

54. A method according to claim 48, said receiver further comprising a counter associated with a said channel and the method including incrementing said counter for said channel if said receiver determines that the detected data in that channel does not comprise a security signal which is plausible.

55. A method according to claim 48, said receiver further comprising a counter associated with a said channel and the method including incrementing said counter for a said channel if the detected data in that channel over-runs or if it under-runs a security signal which is plausible.

56. A method according to claim 55, including incrementing said counter by a different value for an over-run than for an under-run.

57. A method according to claim 54, including reducing the sensitivity of reception of said receiver for a said channel if said counter exceeds a predetermined level.

58. A method according to claim 57, including reducing the sensitivity in predetermined stages.

59. A method according to claim 54, including stopping said receiver from receiving in a said channel if, despite reducing the sensitivity of said receiver, the detected data in that channel continues to be determined as implausible.

60. A method according to claim 54, including decrementing said counter for a said channel at, towards or after a scan through said range of channels.

61. A method according to claim 60, including decrementing said counter for a said channel by a lower value at, towards or after the end of a scan than said counter would be incremented for an over-run or for an under-run during a scan, whereby the method includes said counter adopting a fast-on but slow-off measure of data plausibility for a channel.

62. A method according to claim 48, including providing said security controller with a signal indicative of a said channel in which a security signal which is plausible was received.

63. A method according to claim 61, including comparing a said channel in which a security signal which is plausible is first received with a said channel in which a following transmission thereof is received and determining, from the spacing between said channels in which said security signal is received, whether said security signal has been relayed using a relaying means or has suffered interference or has been corrupted.

64. A method according to claim 44, including transmitting a said security signal first in one of said channels and then in a further one or more than one of said channels.

65. A method according to claim 44, including indicating from said remote transponder to said receiver in which one or more than one of said range of channels said security signal is to be transmitted.

66. A method according to claim 65, including sending to said receiver from said remote transponder an indicating signal which indicates a said channel or channels in which said security signal is to be transmitted.

67. A method according to claim 44, including sending a specifying signal to said remote transponder from said security controller, in which specifying signal said security controller specifies a said channel or channels in which said remote transponder is to transmit a said security signal.

68. A method according to claim 44, including, when said security signal is transmitted in a plurality of channels, altering between transmissions of said security signal the frequency of at least one of the plurality of channels in which said remote transponder transmits a said security signal.

69. A method according to claim 44, including transmitting a said security signal in more than two of said predetermined range of channels and arranging said security controller to respond to said security signal only if it is received by said receiver in at least two channels.

70. A method according to claim 44, including, when a said security signal is transmitted in two or more channels, spacing apart those channels by at least one channel.

71. A method according to claim 44, including waiting for a predetermined delay period after completing a scan through said range of channels before commencing another scan.
